(19) United States
(12) Patent Application Publication
(10) Pub. No.: US 2026/0328322 A1
(43) Pub. Date: Oct. 22, 2026

(54) CONNECTION PIECE HOUSING FOR CONNECTING TO A FLUID LINE, AND SYSTEM COMPRISING THE CONNECTION PIECE HOUSING

(71) Applicant: NORMA GERMANY GMBH, Maintal (DE)

(72) Inventors: Rene SCHINDLER, Maintal (DE); David SCHNEIDER, Maintal (DE)

(21) Appl. No.: 19/113,123

(22) PCT Filed: Sep. 6, 2023
(86) PCT No.: PCT/EP2023/074379

§ 371 Date: Mar. 19, 2025

(30) Foreign Application Priority Data
Sep. 19, 2022 (DE) 10 2022 123 996.9

(51) Int. Cl. F16L 37/098

(52) U.S. Cl. CPC F16L 37/0982

(57) ABSTRACT

A connection piece housing for connecting to a fluid line includes a sleeve portion having an opening for the insertion of a connection piece along a longitudinal axis. A wall which extends in the circumferential direction about the longitudinal axis with an inner surface that delimits the opening is provided. The inner surface has a recess for the leadthrough of a securing tab of a securing element that can be inserted into the opening for the purposes of locking a connection piece that has been inserted through the securing element into the connection piece housing. A receptacle for receiving at least a part of the securing tab is provided. A locking element for locking the securing tab in the receptacle is arranged between the receptacle and the recess.

### INTRODUCTION

The disclosure relates to a connection piece housing for connecting to a fluid line, and to a system comprising the connection piece housing.

Devices which have a connection piece and a connection piece housing can be used for connecting fluid lines. One of the fluid lines to be connected, for example a pipe, is connected to the connection piece, and the other one, such as a hose, is connected to the connection piece housing. The connection piece can be introduced into an opening in the connection piece housing and locked to the connection piece housing by means of a securing element.

Known from DE102020115021A1 is a system having a connection piece housing in which the connection piece is locked to the connection piece housing by a securing element. The securing element has securing tabs which has in the axial direction in a channel and an opening adjoining the latter in the axial direction with a latching edge extending in the circumferential direction. The securing tabs latch into the opening when introduced into the opening.

### SUMMARY

An object of the disclosure, per an embodiment, is to provide an improved connection piece housing in which a connection piece locked in the connection piece housing can be subjected to increased tensile forces in the axial direction.

In a connection piece housing for connecting to a fluid line comprising a sleeve portion having an opening for introducing a connection piece along a longitudinal axis and a wall which extends in the circumferential direction about the longitudinal axis and which, by way of an internal face, delimits the opening, wherein the internal face has a clearance for passing through a securing tab of a securing element introducible into the opening for locking a connection piece introduced into the connection piece housing via the securing element, and a receptacle for receiving at least part of the securing tab, wherein the clearance extends in an axial direction from an axial access on a periphery of the opening, and the receptacle is spaced apart from the periphery of the opening in an axial direction, wherein a locking element for locking the securing tab in the receptacle is disposed between the receptacle and the clearance, it is provided according to an embodiment that the receptacle is disposed so as to be offset from the clearance in a circumferential direction.

The disclosure, per an embodiment, provides a connection piece housing in which the function of introducing the securing tab of the securing element is spatially separated from the function of locking the securing tab in the circumferential direction about the longitudinal axis. The connection piece housing has for introducing the securing element, or the connection piece. On the internal face of the wall that delimits the opening, the connection piece housing comprises a clearance through which a securing tab of a securing element can be introduced in the axial direction. Furthermore, a receptacle is disposed so as to be offset from the clearance in the circumferential direction. In order to dispose the securing tab introduced into the clearance in the receptacle, the securing element must be rotated with the securing tab in the circumferential direction toward the receptacle. On account of the offset of the receptacle in the circumferential direction, holding the securing tab in the receptacle in the axial direction is independent from the introduced position in the clearance. As a result, the receptacle can be designed to be more stable in the axial direction, and a connection piece locked in the connection piece housing can be subjected to an increased tensile force in comparison to the prior art.

Locking the securing tab on the connection piece housing is performed here per an embodiment via a plug-and-twist movement similar to a bayonet fastener. A locking element by way of which the securing tab is locked in the clearance is disposed between the clearance and the receptacle. Here, the locking effected by the locking element blocks a rotation of the securing tab and thus of the securing element in the circumferential direction from the receptacle to the clearance. This rotation is counter to the rotation that moves the securing tab from the clearance into the receptacle.

The terms axial direction, radial direction and circumferential direction each refer to the longitudinal axis of the opening.

According to an example, the locking element can have a latching edge which extends in the axial direction and is spaced from the access in the axial direction.

The latching edge is subjected to less stress when the securing tab is pulled in the axial direction than an edge of the receptacle that extends in the circumferential direction.

According to another example, the receptacle can have a release device for decoupling the securing tab from a connection piece introduced into the opening.

With the release device, a connection piece secured by a securing element locked in the connection piece housing can be released, or unlocked, in order to be removed from the securing element and the connection piece housing.

Furthermore, the release device can have, for example, a ramp face which is beveled radially inward in relation to the axis.

The ramp faces can be disposed on a side of the receptacle that lies opposite the clearance. The securing tab can then be moved over the ramp face by rotating the former away from the clearance. As a result, the securing tab can be moved radially outward via the ramp face. This causes the securing tab to be decoupled from the connection piece and to release the latter.

According to another example, the wall, proceeding from the receptacle in an axial direction pointing out of the opening, can have a greater radial thickness than proceeding from the clearance in a radial direction.

Due to the greater radial thickness, the wall can absorb furthermore increased tensile forces in the axial direction, which are transmitted by the securing tab disposed in the receptacle.

The disclosure, per an embodiment, further relates to a system for connecting fluid lines, comprising a connection piece housing according to the description above, a securing element which is introducible into the opening, and a connection piece which is lockable in the connection piece housing by the securing element, wherein the securing element has at least one securing tab for locking the connection piece in the opening, and the securing tab is introducible in the axial direction through the access into the clearance, wherein the securing tab changes from an initial position to a radially inwardly offset position when introduced into the clearance, and is disposed at least partially in the receptacle by rotating the securing element in the circumferential direction from the clearance, wherein the securing element changes to its initial position when rotated into the receptacle.

Advantages and effects as well as refinements of the system are derived from the advantages and effects as well as refinements of the connection piece housing described above. In this respect, reference is therefore made to the preceding description.

According to an example, the connection piece housing can have at least one release device for decoupling the securing tab from a connection piece introduced into the opening, wherein by rotating the securing element toward the ramp face, the securing tab changes from the initial position to a radially outward position and releases a connection piece locked in the opening.

According to a further example, the securing tab can have a locking member which interacts with the locking element in such a manner that a rotation of the locking member in the circumferential direction from the receptacle to the clearance is locked when the locking member is disposed in the receptacle.

In the receptacle, the locking member can bear in the axial direction on a wall portion that extends in the circumferential direction. Due to the offset of the receptacle in the circumferential direction relative to the clearance, the wall portion can be formed to be strong enough to withstand increased tensile forces in comparison to the prior art.

### BRIEF DESCRIPTION OF THE FIGURES

Further features, details and advantages of the disclosure can be derived from the wording of the claims and also from the following description of exemplary embodiments with reference to the drawings, in which:

FIG. 1 shows a schematic illustration of an embodiment of the connection piece housing;

FIGS. 2a-c show a schematic illustration of the connection piece housing with the securing element; and

FIG. 3 shows a schematic illustration of an embodiment of a system consisting of a connection piece, a securing element and a connection piece housing.

### DETAILED DESCRIPTION

FIG 1. Shows a View of the Connection Piece Housing 10 for Connecting to a Fluid Line Along a longitudinal axis 14.

The connection piece housing 10 has a sleeve portion 12 which has an opening 20. Starting at the opening 20, a fluid channel extends through the connection piece housing 10 and opens out at a further opening on the connection piece housing 10. In this example, the longitudinal axis 14 can extend substantially through the center of the opening 20.

Furthermore, the sleeve portion 12 has a wall 16 which extends about the opening 20. The wall 16 extends in the circumferential direction around the longitudinal axis 14. An internal face 18 of the wall 16 delimits the opening 20. Furthermore, a periphery 28 of the opening 20, as the end face of the wall 16, extends about the opening 20.

The internal face 18 has a clearance 22 which begins at an axial access 26 disposed on the periphery 28 of the opening 20. The clearance 22 can extend in the form of a channel, which is open toward the longitudinal axis 14, in the axial direction along the internal face 18.

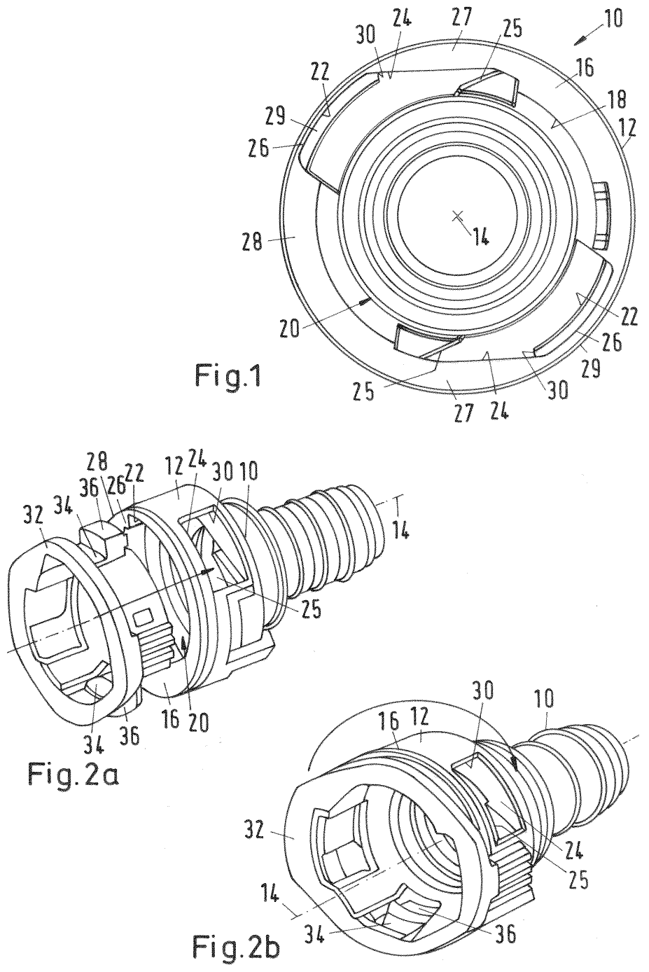

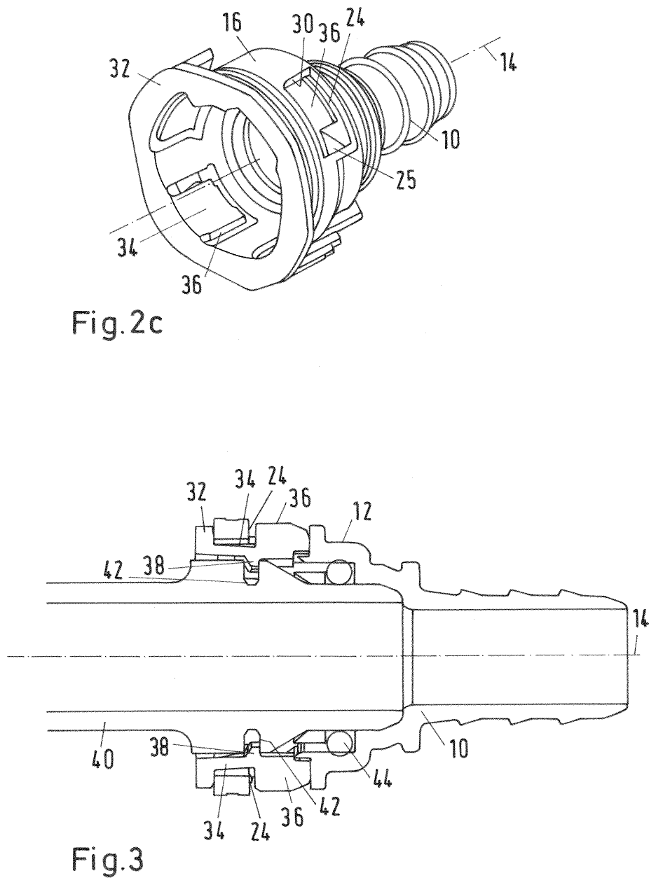

The clearance 22 is designed in such a manner that a securing tab 34 of a securing element 32 can be introduced through the access 26 in the axial direction into the clearance 22, as illustrated in FIG. 2a.

Furthermore, the internal face 18 has a receptacle 24 for at least a part of the securing tab 34 introducible through the clearance 22. The receptacle 24 is disposed so as to be offset in a first circumferential direction next to the clearance 22 and is spaced apart from the periphery 28 of the opening 20 in the axial direction. For a safety tab 34 introduced into the clearance 22, the receptacle 24 is only accessible via the clearance 22.

For this purpose, the securing tab 34 can first be introduced into the opening 20 with the securing element 32 as illustrated in FIG. 2a. In the process, the securing tab 32 is first introduced in the axial direction into the clearance 22.

The opening 20 can have a radius on the clearance, which is smaller than the spacing of the securing tab 34 from the longitudinal axis 14. During insertion, the securing tab 32 can therefore be guided through the clearance 22 from an initial position to a radially inwardly offset position. This means that the securing tab 32 can be bent elastically relative to the longitudinal axis 14 by being introduced into the clearance 22.

As soon as the securing tab 34 has been introduced into the clearance 22, the securing element 32 can be rotated in the first circumferential direction about the longitudinal axis 14, as illustrated in FIG. 2b. In the process, the securing tab 34 is moved from the clearance 22 into the receptacle 24 and disposed as illustrated in FIG. 2c.

At the receptacle 24, the opening 20 can have a larger radius than the distance of the securing tab 34 from the longitudinal axis 14. The securing tab 34 can therefore move from the radially inwardly offset position back to the initial position in the receptacle 24.

A locking element 30 is disposed between the clearance 22 and the receptacle 24. The locking element 30 is designed to lock a securing tab 34 disposed in the receptacle 24. In the rotating movement from the clearance 22 into the receptacle 24, the securing tab 34 is thus moved via the locking element 24.

While passing the locking element 30, the securing tab 34 can be in the radially inwardly offset position. After passing the locking element 30, the securing tab 34 can be moved back to the initial position in the receptacle 24, and is then locked in the receptacle 24 by the locking element 30. In the process, the locking element 30 blocks a movement of the securing tab 34 locked in the receptacle 24 toward the clearance 22. This means that the locking element 30 locks the securing tab 34 in a second circumferential direction, which is counter to the first circumferential direction.

The locking element 30 can be designed as a latching edge. The latching edge can extend in the axial direction between the clearance 22 and the receptacle 24. A securing member 36 which protrudes radially from the securing tab 34 can interact with the latching edge to effect the locking when the securing member 36 and thus the securing tab 32 is disposed in the receptacle 24.

In the axial direction out of the opening 20, the securing tab 34 locked in the receptacle is held in a positive fit by a first wall portion 27. The first wall portion 27 has a thickness in the radial direction which is greater than a thickness of a second wall portion 29 delimiting the clearance 22 in the radial direction. The thickness of the two wall portions 27, 29 here is measured between the boundary surfaces of the wall 16 at the respective position.

In the prior art, in which the receptacle 24 follows in the axial direction after the clearance 22, the receptacle 24 is delimited by the second wall portion 29 in the radial direction out of the opening. Due to the greater thickness of the first wall portion 27 according to this embodiment, the first wall portion 26 can resist increased tensile forces in the axial direction which are transmitted via a securing tab 34 received by the receptacle 24.

In particular in the case of small dimensions, the thickness of the first wall portion 27 can be designed to be greater than in the prior art, due to the separation of the receptacle 24 from the clearance 22 in the circumferential direction, so as to resist comparatively high tensile forces despite the minor dimensions of the connection piece housing 10.

The securing tab 34 can have a first latching element 38 on an outer surface facing the longitudinal axis 24, as shown in FIG. 3. The first latching element 38 can interact with a second latching element 42 which is disposed on a connection piece 40. The connection piece 40 can be introduced via the securing element 32 into the opening 20 of the connection piece housing 10. As soon as the connection piece 40 has reached its intended position in the connection piece housing 10, the first and second latching elements 38, 42 latch into position and secure the connection piece 40 in the connection piece housing 10. The securing tab 34 is then coupled to the connection piece 40. Furthermore, a seal 44 can be disposed between the connection piece 40 and the connection piece housing 10.

In order to remove the connection piece 40 from the connection piece housing 10, the receptacle 24 can have a release device 25 which is designed to decouple the securing tab 34 from the connection piece 40. For this purpose, the release device 25 can have a radially inwardly beveled ramp face which is disposed on the receptacle 24. In this case, the receptacle 24 is disposed in the circumferential direction between the release device 25 and the clearance 22.

By rotating the securing element 32 in the first circumferential direction, i.e. away from the clearance 22, the securing tab 34 is moved to the ramp face. The edge of the ramp face adjacent to the receptacle 24 is disposed closer to the longitudinal axis 14 than the side of the securing tab 34 facing the longitudinal axis 14.

If the securing tab 34 is moved farther in the first circumferential direction, the securing tab 34 therefore moves over the ramp face and is moved to a radially outwardly offset position. As a result, the first latching element 38 is moved radially outwardly away from the second latching element 42, so that the securing tab 34 is decoupled from the connection piece 40.

The connection piece 40 is thus released and can then be removed from the opening 20.

The invention is not restricted to any one of the embodiments described above and instead can be modified in a very wide variety of ways.

All of the features and advantages apparent from the claims, the description and the drawing, including structural details, spatial arrangements and method steps, may be essential to the invention both individually and in a very wide variety of combinations.

Furthermore, in general, while a multitude of embodiments have been described with a multitude of components in each embodiment, in alternative embodiments the components of various embodiments could be intermixed, combined, and/or exchanged for one another. In other words, components described in connection with a particular embodiment are not necessarily exclusive to that particular embodiment.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10 Connection piece housing
12 Sleeve portion
14 Longitudinal axis
16 Wall
18 Internal face
20 Opening
22 Clearance
24 Receptacle
25 Release device
26 Access
27 Wall portion
28 Periphery
29 Wall portion
30 Locking element
32 Securing element
34 Securing tab
36 Locking member
38 Latching element
40 Connection piece
42 Latching element
44 Seal

1. A connection piece housing for connecting to a fluid line, comprising a sleeve portion having an opening for introducing a connection piece along a longitudinal axis and a wall which extends in the circumferential direction about the longitudinal axis and which, by way of an internal face, delimits the opening, wherein the internal face has a clearance for passing through a securing tab of a securing element introducible into the opening for locking a connection piece introduced into the connection piece housing via the securing element and a receptacle for receiving at least part of the securing tab, wherein the clearance extends in an axial direction from an axial access on a periphery of the opening and the receptacle is spaced apart from the periphery of the opening in an axial direction, wherein a locking element for locking the securing tab in the receptacle is disposed between the receptacle and the clearance, wherein the receptacle is disposed so as to be offset from the clearance in a circumferential direction.

2. The connection piece housing as claimed in claim 1, wherein the locking element has a latching edge which extends in the axial direction and is spaced from the access in the axial direction.

3. The connection piece housing as claimed in claim 1, wherein the receptacle has a release device for decoupling the securing tab from a connection piece introduced into the opening.

4. The connection piece housing as claimed in claim 3, wherein the release device has a ramp face which is beveled radially inward in relation to the longitudinal axis.

5. The connection piece housing as claimed in claim 1, wherein the wall, proceeding from the receptacle in an axial direction pointing out of the opening, has a greater radial thickness than proceeding from the clearance in a radial direction.

6. A system for connecting fluid lines, comprising a connection piece housing as claimed in claim 1, securing element which is introducible into the opening, and a connection piece which is lockable in the connection piece housing by the securing element, wherein the securing element has at least one securing tab for locking the connection piece in the opening, and the securing tab is introducible in the axial direction through the access into the clearance, wherein the securing tab changes from an initial position to a radially inwardly offset position when introduced into the clearance, and is disposed at least partially in the receptacle by rotating the securing element in the circumferential direction from the clearance, wherein the securing element changes to its initial position when rotated into the receptacle.

7. The system as claimed in claim 6, wherein the locking element has a latching edge which extends in the axial direction and is spaced from the access in the axial direction, the receptacle has a release device for decoupling the securing tab from a connection piece introduced into the opening, and wherein by rotating the securing element toward the ramp face, the securing tab changes from the initial position to a radially outwardly offset position and releases a connection piece locked in the opening.

8. The system as claimed in claim 6, wherein the securing tab has a locking member which interacts with the locking element in such a manner that a rotation of the locking member in the circumferential direction from the receptacle to the clearance is locked when the locking member is disposed in the receptacle.
